(19) United States
(12) Patent Application Publication
(10) Pub. No.: US 2018/0060728 A1
(43) Pub. Date: Mar. 1, 2018

(54) Deep Embedding Forest: Forest-based Serving with Deep Embedding Features

(71) Applicant: Microsoft Technology Licensing, LLC, Redmond, WA (US)

(72) Inventors: Ying Shan, Sammamish, WA (US); Jianchang Mao, Bellevue, WA (US); Dong Yu, Bothell, WA (US); Holakou Rahmanian, Santa Cruz, CA (US); Yi Zhang, Redmond, WA (US)

(73) Assignee: Microsoft Technology Licensing, LLC, Redmond, WA (US)

(21) Appl. No.: 15/253,669

(22) Filed: Aug. 31, 2016

(51) Int. Cl. G06N 3/08; G06N 3/04

(52) U.S. Cl. CPC G06N 3/08; G06N 3/04

(57) ABSTRACT

A deep embedding forest-based (DEF) model for improving on-line serving time for classification learning methods and other tasks such as, for example, predicting user selection of search results provided in response to a query or for image, speech or text recognition. Initially, a deep neural network (DNN) model is trained to determine parameters of an embedding layer, a stacking layer, deep layers and a scoring layer thereby reducing high dimensional features. After training the DNN model, the parameters of the deep layers and the scoring layer of the DNN model and discarded and the parameters of the embedding layer and the stacking layer are extracted. The extracted parameters from the DNN model then initialize parameters of an embedding layer and a stacking layer of the DEF model such that only a forest layer of the DEF model is then required to be trained. Output from the DEF model is stored in computer memory.

### BACKGROUND

Various deep learning architectures such as Deep Neural Networks (DDN) have been applied to image, voice and text detection. DDN models have the ability to extract high level embedding vectors from low level features. However, DNN models use many more parameters and have a high computation cost which limits their deployment in many scenarios. Thus, serving time becomes a bottleneck due to expensive runtime computation of multiple layers of matrices.

Tree or forest-based models operate by constructing a multitude of decision trees. Forest-based models have a low servicing cost but have high dependencies on carefully engineered features. What is needed is a model that has the benefits of the DDN model but has the inexpensive runtime of the forest-based models. In particular, a deep embedding forest model combines the high dimensional (hundreds of thousands to millions) and the heterogeneous low-level features to the lower dimensional (thousands) vectors of the DDN models and the low serving cost of the forest-based models.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

According to one aspect disclosed herein, a method is presented which includes, in response to received input, accessing a DNN model via a model manager wherein the DNN model includes an embedding layer, stacking layer, deep layers and a scoring layer. The method also includes training the DNN model, initiated by the model manager, to determine parameters of the embedding layer, stacking layer, the deep layers and the scoring layer. After training the DNN model, the parameters of the deep layers and the scoring layer of the DNN model may be discarded. The method then includes initializing parameters of an embedding layer of a Deep Embedding Forest (DEF) model with the remaining parameters extracted from the deep layers of the trained DNN model and initializing parameters of a stacking layer of the DEF model with the remaining parameters extracted from the stacking layer of the trained DNN model. The method may also include replacing the deep layers and the scoring layer of the DNN model with a forest layer to thereby define the DEF model, initializing the forest layer of the DEF model utilizing a gradient boosting machine, such as XEBoost, and jointly optimizing the parameters of both the embedding layer and the forest layer of the DEF model after fully initializing the DEF model as a result of initializing the embedding and stacking layers of the DEF model and initializing the forest layer of the DEF model utilizing the gradient boosting machine.

According to another aspect disclosed herein, a system is presented that includes at least one processor and an operating environment executing using the at least one processor. The system also includes a model manager configured to perform actions comprising accessing a DNN model comprising an embedding layer, stacking layer, deep layers and a scoring layer, training the DNN model to determine parameters of the embedding layer, stacking layer, the deep layers and the scoring layer, and after training the DNN model, discarding the parameters of the deep layers and the scoring layer of the DNN model. The model manager is further configured to perform the actions of initializing parameters of an embedding layer and a stacking layer of a DEF model with the remaining parameters extracted from the embedding and stacking layers of the trained DNN model, applying the initialized parameters of the embedding layer of the DEF model to features of the DEF model to generate a stacking vector, providing the stacking vector to a forest layer of the DEF model, and training only the forest layer of the DEF model, thereby using less memory and computation power.

According to yet another aspect disclosed herein, a computer-readable storage medium including instructions is presented. The instructions executed by a processor include accessing a DNN model comprising an embedding layer, stacking layer, deep layers and a scoring layer. The instructions also include training the DNN model to determine parameters of the embedding layer, stacking layer, the deep layers and the scoring layer. After training the DNN model, the parameters of the deep layers and the scoring layer of the DNN model are discarded. The instructions further include initializing parameters of an embedding layer and a stacking layer of a DEF model with the remaining parameters extracted from the embedding and stacking layers of the trained DNN model.

Examples may be implemented as a computer process, a computing system, or as a computer program product for one or more computers. According to an aspect, the computer program product is a server of a computer system having a computer program comprising instructions for executing a computer process.

The details of one or more aspects are set forth in the accompanying drawings and description below. Other features and advantages will be apparent from a reading of the following detailed description and a review of the associated drawings. It is to be understood that the following detailed description is explanatory only and is not restrictive of the claims.

### BRIEF DESCRIPTION OF THE DRAWINGS

FIG. 1 illustrates an example of a structure of a Deep Neural Network (DNN);

FIG. 2 illustrates an example of a decision tree/forest model;

FIG. 3 illustrates the architecture of a deep embedding forest (DEF) model according to at least one embodiment disclosed herein;

FIG. 4 illustrates the architecture of a DNN model as a deep crossing model according to at least one embodiment disclosed herein;

FIG. 5 illustrates a flowchart showing general stages for implementing a DEF model according to at least one embodiment disclosed herein;

FIG. 6 shows a system using a DEF model in making predictions regarding search query results or for an image, speech or text recognition system according to embodiments disclosed herein;

FIG. 7 illustrates an exemplary online system utilizing the DEF model according to at least one embodiment disclosed herein; and

FIGS. 8, 9A, 9B and 10 illustrate a variety of operating environments in which various embodiments may be practiced.

### DETAILED DESCRIPTION

The following detailed description refers to the accompanying drawings. Wherever possible, the same reference numbers are used in the drawings and the following description refers to the same or similar elements. While examples may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description is not limiting, but instead, the proper scope is defined by the appended claims. Examples may take the form of a hardware implementation, or an entirely software implementation, or an implementation combining software and hardware aspects. The following detailed description is, therefore, not to be taken in a limiting sense.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

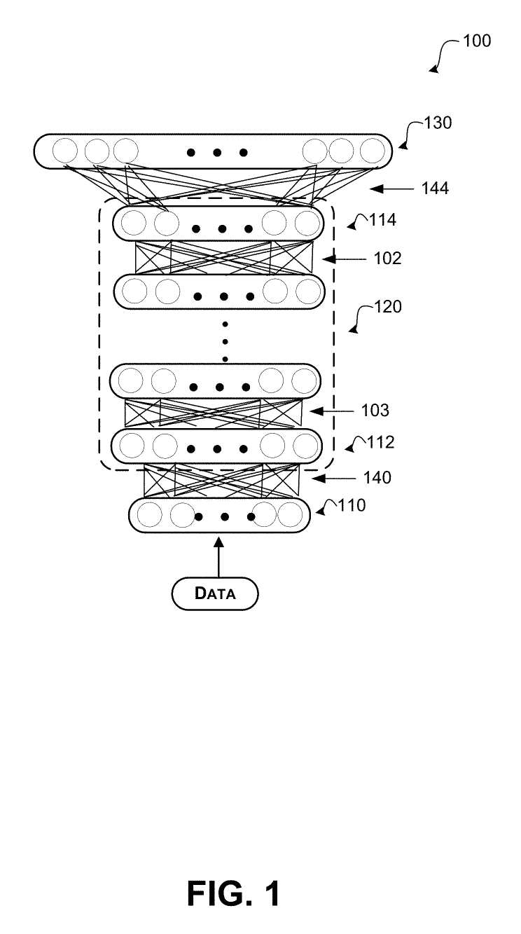

FIG. 1 illustrates the structure of a Deep Neural Network (DNN) with weighted matrices. As illustrated, DNN model 100 includes a bottom input layer 110, hidden layers 120, and a top output layer 130. Generally, a DNN model is fully connected between adjacent layers (e.g. each neuron in a bottom layer is connected to each neuron in a top layer). DNNs can include 5-8 hidden layers and each layer then includes thousands of neurons resulting in millions of calculations when using the DNN model for evaluating input. Using the same amount of training data, a DNN model typically has 2 to 10 times more parameters than traditional systems (e.g. CD-Gaussian Mixture Model (GMM)-HMMs).

As illustrated in FIG. 1, DNN model 100 includes input layer 110 that is coupled to first hidden layer 112 using weight matrix 140 and a last hidden layer 114 that is coupled to output layer 130 using weight matrix 144. Adjacent layers between the first and last hidden layer are coupled using weight matrices (e.g. weight matrix 102, weight matrix 106, . . . ). Each weight matrix may include millions of parameters. These weight matrices are typically sparse and a large portion of the weight parameters in each weight matrix are very small (e.g. zero, or near zero in value). Generally, these very small weight parameters have a negligible effect on the output values of each layer.

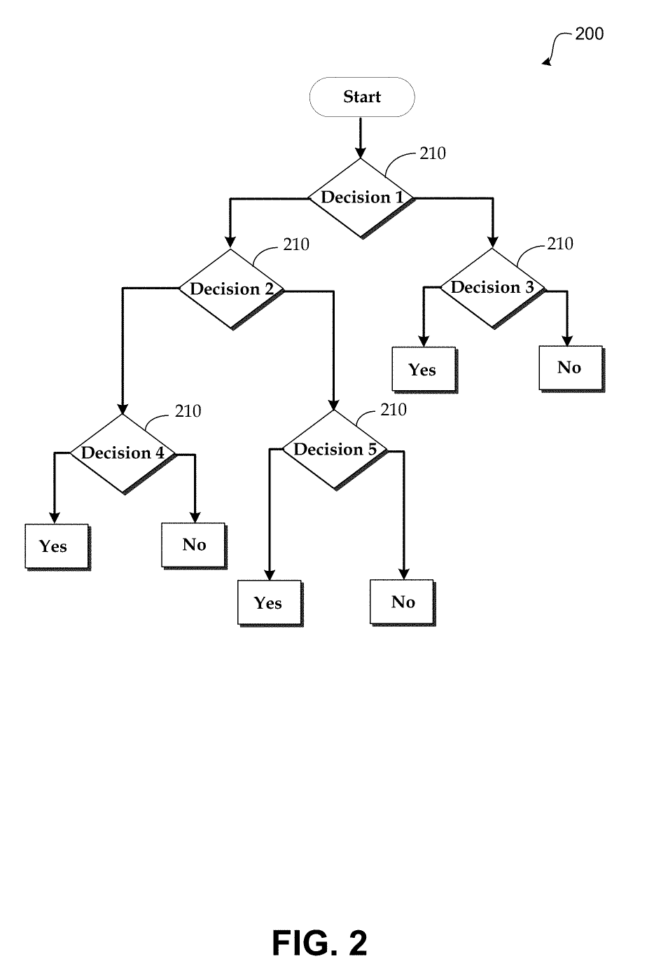

FIG. 2 illustrates a random tree learning model 200 which operates by progressively constructing a multitude of decision trees. Each internal node 210 represents a decision or test on an attribute and each branch represents the outcome of the test and each leaf node represents a class label (decision taken after computing all attributes). The results of a decision by an internal node 210 may be referred to as either a left child or a right child and in FIG. 2, for example, are depicted by either a YES or a NO. The paths from root to leaf represents classification rules. Although FIG. 2 illustrates five nodes 210, the model 200 may include more or less based on the number of data samples and dimensions in order to progressively train the model 200. In one or more embodiments, a model may have more than one tree thereby defining a forest-based learning model.

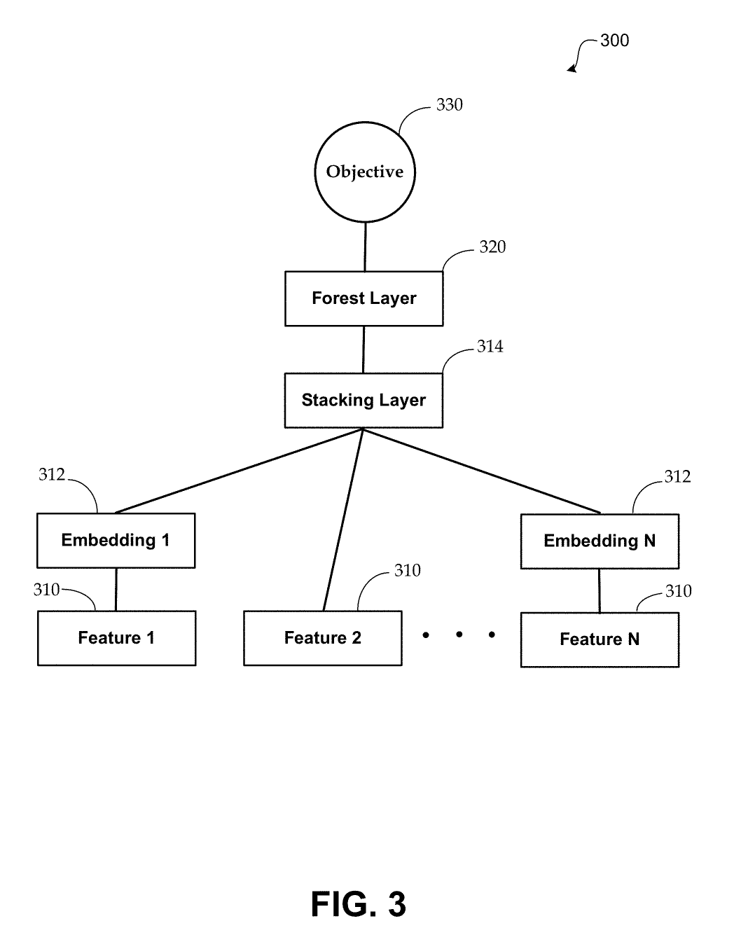

FIG. 3 illustrates the architecture of a deep embedding forest (DEF) model 300 according to at least one embodiment. DEF model 300 allows objective functions of various types including but not limited to classification, regression and ranking. In at least one embodiment, DEF model 300 allows for low level features of different nature including sparse one-hot or categorical features as well as dense numerical features. Thus, as shown in FIG. 3 the DEF model 300 may include any number of features 310 (Features 1, 2 . . . N). The sources from which these features 310 may be extracted include search query results or text, speech or image sources.

The DEF model 300 also includes an embedding layer 312 (Embedding 1, . . . N) which maps the low level features to a different feature space. The embedding layer 312, as a single layer of neural network, has the general form of:

\tilde{y}ⱼ=g(Wⱼxⱼ+bⱼ), (1)

where j is the index to the individual features xⱼεR^{nj}, Wⱼ is an mⱼ×nⱼ matrix, bεR^{mj}, is the vector of the bias terms, \tilde{y}ⱼ is the embedding vector, and g(•) is a non-linear activation function such as ReLU, sigmoid, or tan h. When mⱼ<nⱼ, embedding is used to reduce the dimensionality of the input feature.

The stacking layer 314 concatenates the embedding features into one vector as the following:

\tilde{y}=[\tilde{y}₀,\tilde{y}₁, . . . ,\tilde{y}_{K}], (2)

where K is the number of individual features. In one or more embodiments, the features with low dimensionality are stacked without embedding. For example, in FIG. 3 feature 2 (reference number 310) is stacked without embedding.

The stacking vector is then input to the forest layer 320 which is represented as [symbol] (Ψ, θ, π), where Ψ defines the number of tress in the forest and corresponding structure, θ is the parameter set of the routing functions on the decision nodes, and π is the parameter set of the distribution functions on leaf nodes.

The DEF model 300 of FIG. 3 also includes objective 330 which represents an objective function such as regression, classification or a ranking objective function.

Training the DEF model 300 requires optimization of the objective function with respect to {Wⱼ}, {bⱼ}, Ψ, θ and π. Ideally, a joint optimization that solves these parameters is preferred. Specifically, the search of the best structure and the corresponding decisions and weight parameters in the forest layer usually relies on approaches which are not compatible with the gradient-based search for the neural-based embedding layers.

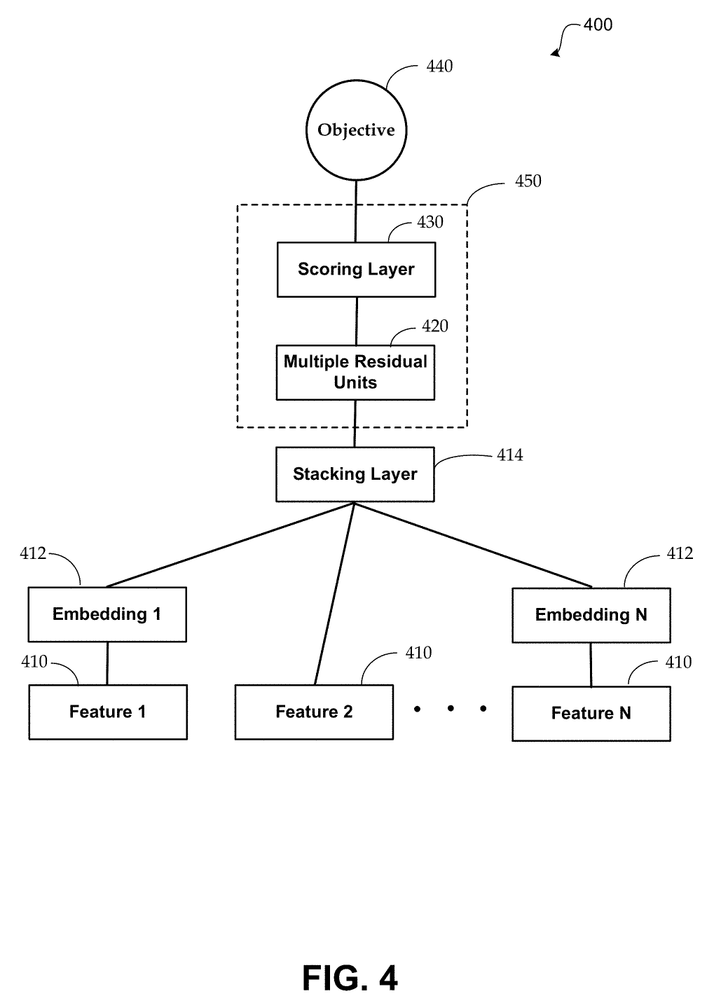

Thus, the DEF model 300 receives initialization of {Wⱼ} and {bⱼ} from a DNN model such as a deep crossing model. Preferably, the DNN model for initializing the DEF model 300 is a deep crossing model wherein the deep layers are multiple residual units. FIG. 4 illustrates the architecture of a representative deep crossing model 400 according to at least one embodiment. The first three layers of the deep crossing model 400 of FIG. 4 are similar to the first three layers of the DEF model 300 of FIG. 3. The deep crossing model 400 of FIG. 4 includes any number of features 410 (Features 1, 2 . . . N). The sources from which these features 410 may be extracted include search query results or text, speech or image sources.

The deep crossing model 400 also includes an embedding layer 412 (Embedding 1, . . . N) which maps the low level features to a different feature space. The embedding layer 412, is also a single layer of neural network, and the stacking layer 414 concatenates the embedding features into one vector as described above in regard to the DEF model 300 of FIG. 3.

The deep crossing model 400 of FIG. 4 contrasts with the DEF model 300 of FIG. 3 in that the deep crossing model 400 includes a layer of multiple residual units 420 and a scoring layer 430. The layer of multiple residual units 420 is preferably a cascade or layered structure of neurons. For example, each residual unit 420 consists of two layers of neurons. The output of the last residual unit is then passed onto the scoring layer 430 which consists of another layer of neurons for providing vector scores. The deep crossing model 400 of FIG. 4 also includes objective 440 which represents an objective function such as regression, classification or a ranking objective function, which may be customized. The vector scores may then be compared with labels via statistical classification.

Thus, the objective 440 is optimized via a backpropagation method where the various parameters within the embedding layer 410, the residual units layer 420, and the scoring layer 430 are updated thereby tuning the deep crossing model of FIG. 4. Upon concluding training of the deep crossing model 400, which is an end-to-end model training process, the parameters of the trained model 400 within the box 450, which may be referred to as a classification layer, are discarded and the remaining trained layers of the embedding layer 412 and the stacking layer 414 of the trained model 400, which may be referred to as the feature extraction layers, are provided to the DEF model 300 of FIG. 3. In other words, although the model 400 has been trained, the parameters of the residual units layer 420 and the score layer 430 are eliminated by replacing them with the forest layer 320 to define a DEF model. Thus, the parameters of the embedding layer 412 are extracted from the deep crossing model 400 and are provided to the DEF model 300 in order to then conduct training within the DEF model 300 utilizing the parameters from the embedding layer 412 of the trained model 400. The extracted parameters now included with the embedding layer 312 and the vector of stacking layer 314 are then provided as input to the forest layer 320. Thus, only the forest layer 320 of DEF model 300 is then required to be trained.

The embedding layers 312 of the DEF model 300 establish a forward function that maps the raw features into the stacking vector of the stacking layer 314. The stacking vector is:

\tilde{y}ᵢ=g({xⱼ}ᵢ;{W⁰ⱼ},{b⁰ⱼ}), (3)

where i is the index to the training samples. The initial values of the embedding parameters are denoted as {W⁰ⱼ} and {b⁰ⱼ}.

Initialization of the forest layer 320 to build the DEF model 300 may also then include training a gradient boosting machine such as an XGBoost model which is a scalable tree boosting system which is itself known to those with skill in this art. Training the XGBoost model uses the mapped sample and target pairs {(tᵢ, \tilde{y}ᵢ)}, where tᵢ is the target of the i^{th} training sample. Utilizing XGBoost to fully or further initialize the DEF model 300 results in superior performance both in accuracy and runtime speed. The output of utilizing XGBoost as part of the initialization process is the initial values of the parameters of the forest layer 320 including Ψ⁰, θ⁰, π⁰. In other words, utilizing XGBoost determines the initial parameters of the forest layer 320 thereby commencing training of the forest layer 320. Upon full initialization of the DEF model 300, joint optimization may then be used to refine the fully initialized parameters of the embedding layers 312 relative the fully initialized parameters of the forest layer 320.

Fuzzification of the decisions at the internal nodes of the forest layer 320 may occur rather than making binary decisions. A fuzzy split function is defined as:

μ^{r}_{{L,R}}(\tilde{y})=1/(1+e^{-(v\tilde{y}-ur)}), (4)

where vᵣ is the weight vector, uᵣ is a scalar, and \tilde{y}≡\tilde{y}ⱼ is the stacking vector of the j^{th} training sample. The index j is dropped for simplicity and the functions μ^{r}_{L} and μ^{r}_{R} are defined for the left child and the right child (if exists), respectively. The prediction of the target is:

t̅=Σ_{lε} [symbol] μₗ(\tilde{y})πₗ, (5)

where l is a leaf node in the set of all leaf nodes [symbol] , μl(•) is the probability of \tilde{y} landing in l, and πₗ is the corresponding prediction. Note that μl(•) is a function of all {μ^{r}_{{L,R}}} along the path from the root l.

A direct benefit of fuzzification is that a continuous loss function Loss ({tⱼ, t̅ⱼ}) is differentiable with respect to {vᵣ}, {uᵣ} and {πₗ}. The downside, however, is the cost of the prediction, which requires the transversal of the entire tree, as indicated in equation 5. From equation 4, it can be seen that the split function depends on all dimensions of the stacking features which is computationally expensive.

DEF model 300 also may include partial fuzzification that separates the routing function with the prediction function. It keeps the structure Ψ⁰ and the binary routing functions θ⁰ resulting from the XGBoost-based initialization. The partial fuzzification is only for the prediction function on each node defined as:

μ^{r}_{{L,R}}(\tilde{y}^{r})=1/(1+e^{-(wr\tilde{y}r-ur)}), (6)

where wᵣ and uᵣ are prediction parameters on the r^{th} node. As compared with the split function in equation 4, wᵣ is a scalar instead of a vector. This is because each node is dedicated to only one dimension of the stacking feature, which is denoted as \tilde{y}^{r} in equation 6. More specifically, \tilde{y}^{r} is the feature value of the dimension selected by the r^{th} node based on Ψ⁰ and θ⁰. The prediction is then given by:

t̅=πₗΠ_{rεΩ}μ^{r}_{{L,R}}(\tilde{y}^{r}), (7)

where Ω is the routing path for a stacking vector \tilde{y} that lands on the l^{th} leaf node.

It can be seen from equations 6 and 7 that partial fuzzification depends on only one dimensions and does not require full traversal which reduces runtime speed significantly. Partial fuzzification is compatible with gradient-based optimization. Like with full fuzzification, the loss function Loss ({tⱼ, t̅ⱼ}) is differentiable from {vᵣ}, {uᵣ} and {πₗ}. In the context of the DEF model 300, the single dimension and single path-based partial fuzzification enables propagating errors from the forest layer 320 to the embedding layers 312 which makes joint optimization possible.

Experimental results for clicking on an advertisement include training data of 3.64 million samples while the test data had 3.59 million samples. Query strings are converted into 50 thousand tri-letter grams and keywords and title strings are converted as well. The raw input feature has approximately 150 thousand total dimensions and is very sparse. Both the deep crossing model and XGBoost used the same log loss function as the objective. The embedding vector was 128 dimensional for each tri-letter gram. This lead to a stacking vector of 384 dimensions. Deep crossing used two residual units each with a hidden layer of 512 neurons. The DEF model 300 was initialized by the deep crossing model which converged after 8 epochs and produced a log loss of 0.3676.

Next, the stacking vectors were generated based on forward computation of the deep crossing model. The stacking vectors were used as the input to the XGBoost model. XGBoost produced a log loss of 0.3665 after 1000 interactions with a maximum depth of 6.

The prediction time per sample for the full deep crossing model versus the DEF model 300 is 1.287 ms and 0.171 ms, respectively. Note that the speedup was achieved with the DEF model 300 performing slightly better on terms of log loss. If the goal is to achieve on-par performance in practice, the number of iterations (trees) can be significantly reduced to further reduce the runtime latency. These results did not occur as a result of utilizing joint optimization.

When designed and implemented properly, the DEF model 300 provides at least two advantages as a result of its architecture. The DEF model 300 minimizes manual feature engineering. It is a challenge for tree/forest-based models to process low level features exceeding tens of thousands of dimensions. The embedding layers 312 can comfortably operate on dimensions 10 or 100 times higher and automatically generate high level embedding features to the size manageable by the tree/forest-based models. For example, deep crossing model reduces high dimensional features in the range of hundreds of thousands to millions to lower dimensional vectors of less than 10 thousand for initializing the forest layer.

The DEF model 300 also minimizes runtime latency. Based on the architecture of FIG. 3, the serving time per sample is determined by the embedding time T₁ and prediction time T₂. Prediction in this context refers to general scoring operation that is applicable to classification, regression and ranking. As mentioned above, T₁ is zero for dense numerical features. The complexity of embedding a sparse feature is O(n_{ō} nₑ), where n_{ō} is the number of non-zero elements and nₑ is the dimension of the corresponding embedding vector. As an example, a sparse tri-letter gram has approximately 50 thousand dimensions but usually with n_{ō}≦30. For a typical nₑ between 128 and 256 the runtime cost of an embedding layer is negligible.

The prediction time T₂ is a function of nₜdₜn_{f}, where nₜ is the number of trees, dₜ is the average depth of trees in the forest, and n_{f} is the total number of features dimensions the decision or routing function depend on at each internal (or non-leaf) node. DEF model 300 uses decision nodes that rely on only one feature dimension to ensure serving speed. T₂ is then proportional to nₜdₜ, which is fast and independent to the dimensions of the stacker vector. This is cheaper than a typical DNN model with multiple layers of neurons.

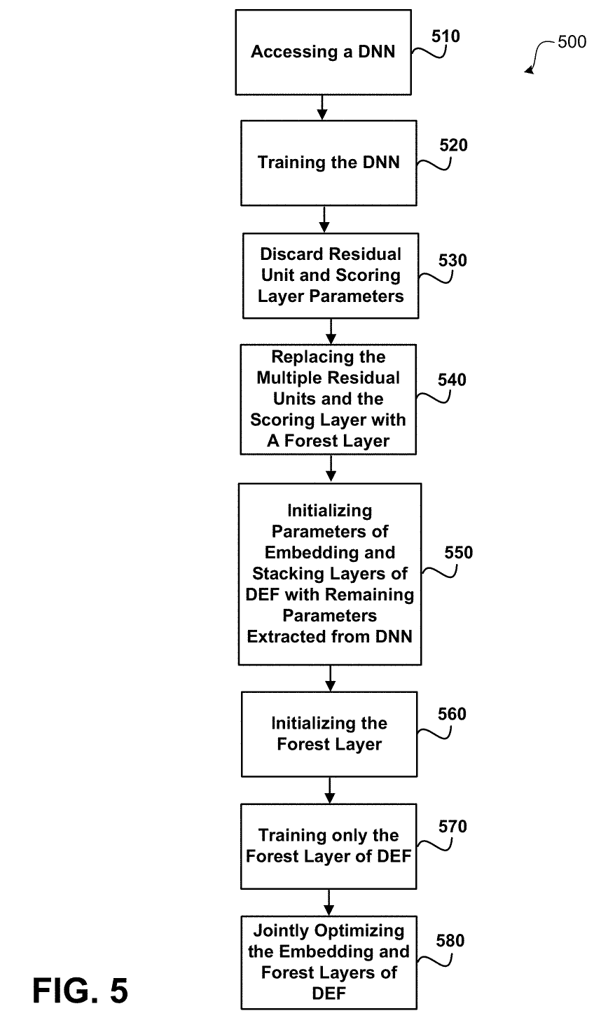

FIG. 5 illustrates a flowchart of a process 500 showing general stages for implementing a DEF model 300 according to at least one embodiment. The process 500 includes process block 510 for accessing a DNN model such as the deep crossing model 400 of FIG. 4. Process block 520 then includes training the DNN model. The parameters of the multiple residual units 420 and the scoring layer 430 are then discarded in process block 530 and a forest layer 320 replaces the multiple residual units 420 and the scoring layer 430 in process block 540. In process block 550 the remaining parameters extracted from the embedding and stacking layers of the trained DNN model then initialize parameters of an embedding layer and a stacking layer of a DEF model 300. The process 500 also includes the process block 560 for initializing the forest layer 320 of the DEF model 300. In one or more embodiments the forest layer 320 is initialized by a gradient boosting machine such as XGBoost. Process block 570 includes training only the forest layer 320 of the DEF model 300. The process 500 may also include process block 589 for jointly optimizing the embedding and forest layers of the DEF model 300. Thus, the parameters of both the embedding layer and forest layer of the DEF model 300 are jointly optimized after fully initializing the DEF model 300 as a result of initializing the embedding and stacking layers of DEF model 300 and initializing the forest layer of the DEF model utilizing the gradient boosting machine.

Embodiments, for example, are described above with reference to block diagrams and/or operational illustrations of methods, systems, and computer program products according to embodiments. The functions/acts noted in the blocks may occur out of the order as shown in any flowchart or described herein with reference to the Figures. For example, two steps or processes shown or described in succession may in fact be executed substantially concurrently or the blocks may sometimes be executed in the reverse order, depending upon the functionality/acts involved.

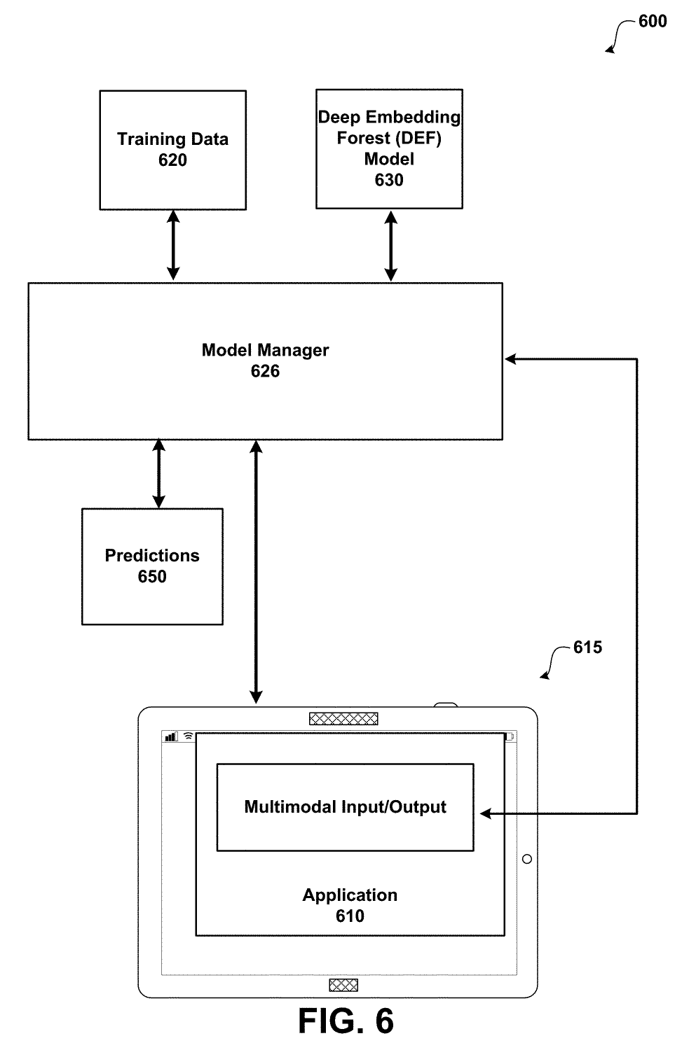

FIG. 6 illustrates a DEF model used in a system for predicting whether a user selects particular search results generated from a search query. However, the DEF model of FIG. 6 may be utilized in other contexts such as text, speech and image recognition. System 600 includes application 610, touch screen input device 615, training data 620, model manager 626, DEF model 630 and predictions 650.

The touch screen input device 615 receives user input to initiate a search query via the application 610 in order to provide query results. Model manager 626 accesses the DEF model 630 for use in predicting which query results are most likely to be selected by the user. The query results via the model manager 626 are used in training the DNN model 630 to make the predictions 650. For example, evaluation of input received in application 610 (e.g. received from touch screen input device 615) occurs using DEF model 630 via model manager 626. The DEF model 630 is performed until the objective of the DEF model 630 is reached. In order to facilitate communication with the model manager 626, one or more callback routines, may be implemented.

According to one embodiment, application 610 receives input from a touch-sensitive input device 615 and/or other input devices. For example, voice input, keyboard input (e.g. a physical keyboard and/or SIP), video based input, and the like. Application program 610 may also provide multimodal output (e.g., for purposes of speech, graphics, vibrations, sounds, . . . ). Model manager 626 may provide information to/from application 610 in response to user input (e.g. speech/gesture). For example, a user may initiate or perform a search query using the application 610 or, alternatively, the application 610 may be an image, text or speech related application.

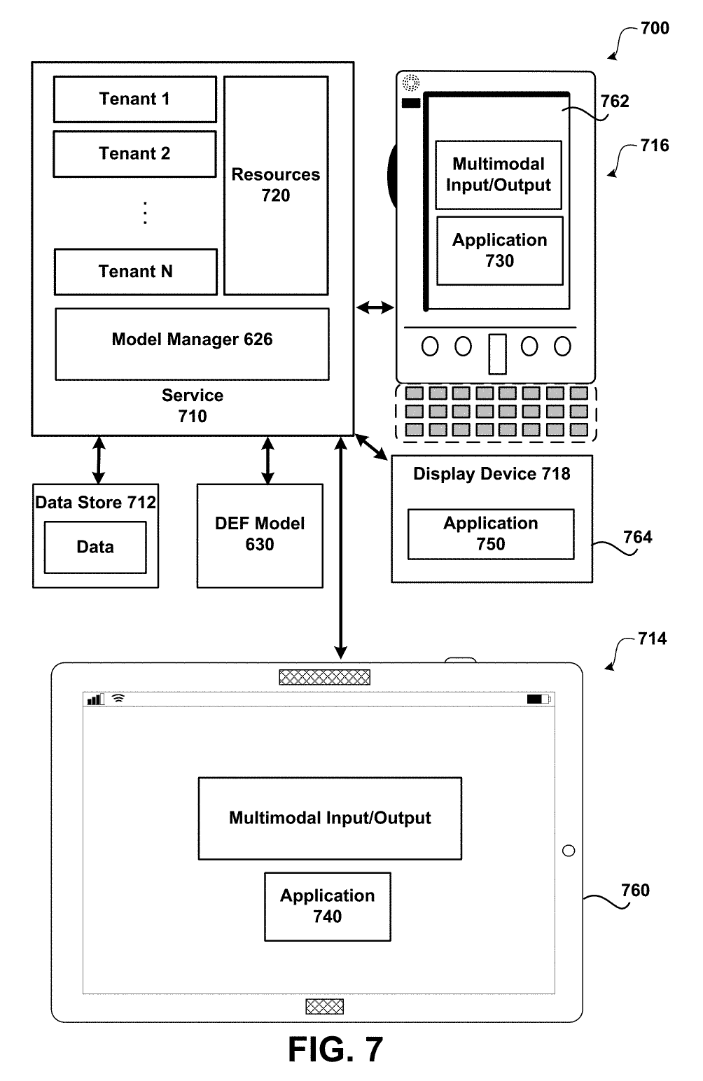

FIG. 7 illustrates an exemplary online system utilizing a DEF model. As illustrated, system 700 includes service 710, data store 712, DEF model 630, touch screen input device 714 (e.g. a slate), smart phone 716 and display device 718. As illustrated, service 710 is a cloud based and/or enterprise based service that may be configured to provide services, such as multimodal services related to various applications (e.g. searching, games, browsing, locating, productivity services (e.g. spreadsheets, documents, presentations, charts, messages, and the like)). The service may be interacted with using different types of input/output. For example, a user may use speech input, touch input, hardware based input, and the like. The service may provide speech output that combines pre-recorded speech and synthesized speech. Functionality of one or more of the services/applications provided by service 710 may also be configured as a client/server based application.

As illustrated, service 710 is a multi-tenant service that provides resources 720 and services to any number of tenants (e.g. Tenants 1-N). Multi-tenant service 710 is a cloud based service that provides resources/services 720 to tenants subscribed to the service and maintains each tenant's data separately and protected from other tenant data. System 700 as illustrated comprises a touch screen input device 714 (e.g. a slate/tablet device) and smart phone 716 that detects when a touch input has been received (e.g. a finger touching or nearly touching the touch screen). Any type of touch screen may be utilized that detects a user's touch input. For example, the touch screen may include one or more layers of capacitive material that detects the touch input. Other sensors may be used in addition to or in place of the capacitive material. For example, Infrared (IR) sensors may be used. According to an embodiment, the touch screen is configured to detect objects that in contact with or above a touchable surface. Although the term “above” is used in this description, it should be understood that the orientation of the touch panel system is irrelevant. The term “above” is intended to be applicable to all such orientations. The touch screen may be configured to determine locations of where touch input is received (e.g. a starting point, intermediate points and an ending point). Actual contact between the touchable surface and the object may be detected by any suitable means, including, for example, by a vibration sensor or microphone coupled to the touch panel. A non-exhaustive list of examples for sensors to detect contact includes pressure-based mechanisms, micro-machined accelerometers, piezoelectric devices, capacitive sensors, resistive sensors, inductive sensors, laser vibrometers, and LED vibrometers.

According to an embodiment, smart phone 716, touch screen input device 714, and display device 718 are configured with multimodal applications and each include an application (730, 740, 750) that is configured to receive input such as, but not limited to, a search query or speech input.

As illustrated, touch screen input device 714, smart phone 716, and display device 718 shows exemplary displays 760/762/764 showing the use of an application using multimodal input/output. Data may be stored on a device (e.g. smart phone 716, touch screen input device 714 and/or at some other location (e.g. network data store 712). Data store 712, or some other store, may be used to store data. The applications used by the devices may be client based applications, server based applications, cloud based applications and/or some combination. According to an embodiment, display device 718 is a device such as a MICROSOFT XBOX coupled to a display.

Model manager 626 is configured to perform operations relating to a DEF model. While manager 626 is shown via service 710, the functionality of the manager may be included in other locations (e.g. on smart phone 716 and/or touch screen input device 714 and/or device 718). The DEF model may be included on smart phone 716, 714, 718.

The embodiments and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), handheld devices, multiprocessor systems, microprocessor-based or programmable consumer electronics, minicomputers, and mainframe computers.

In addition, the embodiments and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

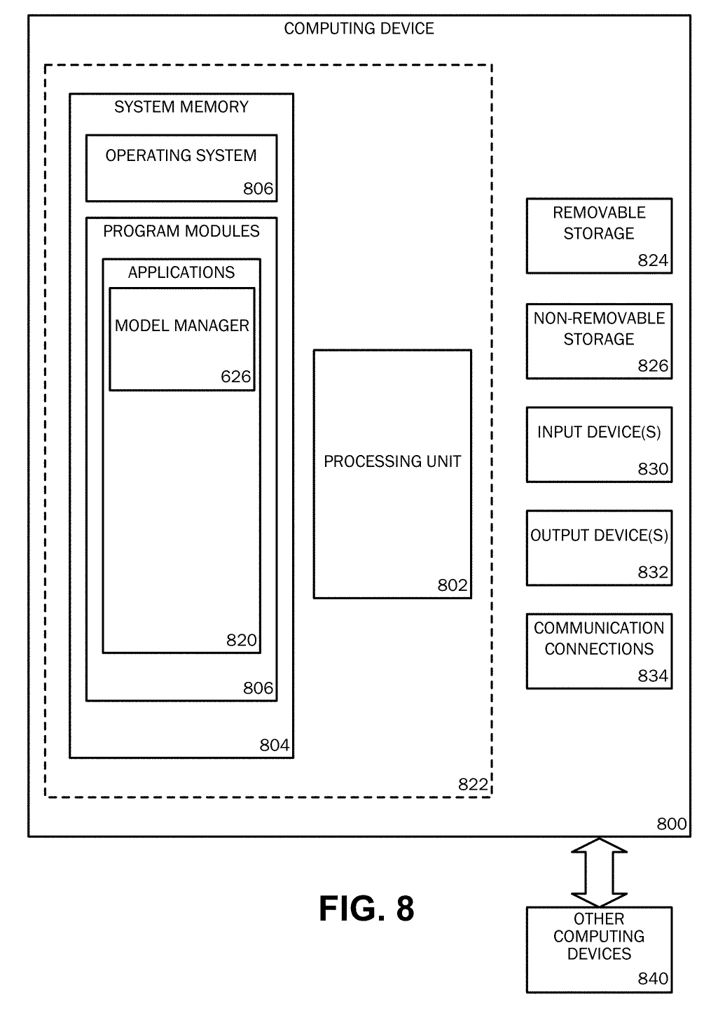

FIGS. 8, 9A, 9B and 10 and the associated descriptions provide a discussion of a variety of operating environments in which embodiments of the invention may be practiced. However, the devices and systems illustrated and discussed with respect to FIGS. 8, 9A, 9B and 10 are for purposes of example and illustration and are not limiting of a vast number of computing device configurations that may be utilized for practicing embodiments of the invention, described herein.

FIG. 8 is a block diagram illustrating physical components (i.e., hardware) of a computing device 800 with which embodiments of the invention may be practiced. The computing device components described below may be suitable for the computing devices described above. In a basic configuration, the computing device 800 may include at least one processing unit 802 and a system memory 804. Depending on the configuration and type of computing device, the system memory 804 may comprise, but is not limited to, volatile storage (e.g., random access memory), non-volatile storage (e.g., read-only memory), flash memory, or any combination of such memories. The system memory 804 may include an operating system 806 and one or more program modules 808 suitable for running software applications 820 such as the model manager 626. The operating system 806, for example, may be suitable for controlling the operation of the computing device 800. Furthermore, embodiments of the invention may be practiced in conjunction with a graphics library, other operating systems, or any other application program and is not limited to any particular application or system. This basic configuration is illustrated in FIG. 8 by those components within a dashed line 822. The computing device 800 may have additional features or functionality. For example, the computing device 800 may also include additional data storage devices (removable and/or non-removable) such as, for example, magnetic disks, optical disks, or tape. Such additional storage is illustrated in FIG. 8 by a removable storage device 824 and a non-removable storage device 826.

As stated above, a number of program modules and data files may be stored in the system memory 804. While executing on the processing unit 802, the program modules 808 (e.g., the model manager 626) may perform processes including, but not limited to, one or more of the stages of the methods and processes illustrated in the figures. Other program modules that may be used in accordance with embodiments of the present invention may include electronic mail and contacts applications, word processing applications, spreadsheet applications, database applications, slide presentation applications, drawing or computer-aided application programs, etc.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. For example, embodiments of the invention may be practiced via a system-on-a-chip (SOC) where each or many of the components illustrated in FIG. 8 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the model manager 626 may be operated via application-specific logic integrated with other components of the computing device 800 on the single integrated circuit (chip). Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

The computing device 800 may also have one or more input device(s) 830 such as a keyboard, a mouse, a pen, a sound input device, a touch input device, etc. The output device(s) 832 such as a display, speakers, a printer, etc. may also be included. The aforementioned devices are examples and others may be used. The computing device 800 may include one or more communication connections 834 allowing communications with other computing devices 840. Examples of suitable communication connections 834 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 804, the removable storage device 824, and the non-removable storage device 826 are all computer storage media examples (i.e., memory storage.) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 800. Any such computer storage media may be part of the computing device 800. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

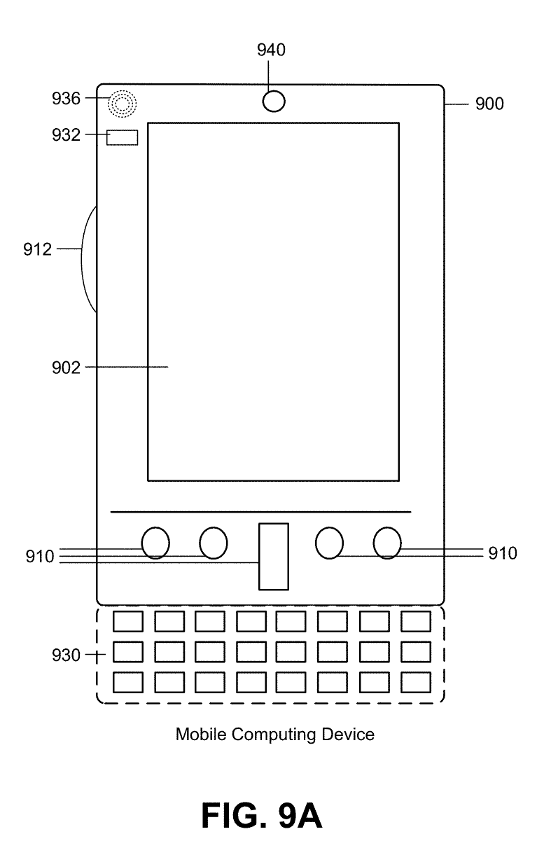

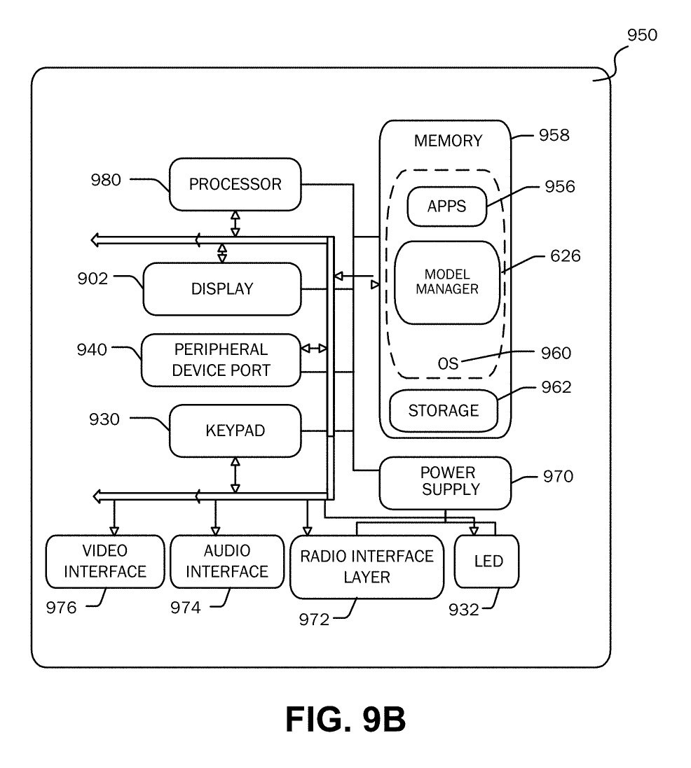

FIGS. 9A and 9B illustrate a mobile computing device 900, for example, a mobile telephone, a smart phone, a tablet personal computer, a laptop computer, and the like, with which embodiments of the invention may be practiced. With reference to FIG. 9A, one embodiment of a mobile computing device 900 for implementing the embodiments is illustrated. In a basic configuration, the mobile computing device 900 is a handheld computer having both input elements and output elements. The mobile computing device 900 typically includes a display 902 and one or more input buttons 910 that allow the user to enter information into the mobile computing device 900. The display 902 of the mobile computing device 900 may also function as an input device (e.g., a touch screen display). If included, an optional side input element 912 allows further user input. The side input element 912 may be a rotary switch, a button, or any other type of manual input element. In alternative embodiments, mobile computing device 900 may incorporate more or less input elements. For example, the display 902 may not be a touch screen in some embodiments. In yet another alternative embodiment, the mobile computing device 900 is a portable phone system, such as a cellular phone. The mobile computing device 900 may also include an optional keypad 930. Optional keypad 930 may be a physical keypad or a “soft” keypad generated on the touch screen display. In various embodiments, the output elements include the display 902 for showing a graphical user interface (GUI), a visual indicator 932 (e.g., a light emitting diode), and/or an audio transducer 936 (e.g., a speaker). In some embodiments, the mobile computing device 900 incorporates a vibration transducer for providing the user with tactile feedback. In yet another embodiment, the mobile computing device 900 incorporates input and/or output ports, such as an audio input (e.g., a microphone jack), an audio output (e.g., a headphone jack), and a video output (e.g., a HDMI port) for sending signals to or receiving signals from an external device.

FIG. 9B is a block diagram illustrating the architecture of one embodiment of a mobile computing device. That is, the mobile computing device 900 can incorporate a system 950 (i.e., an architecture) to implement some embodiments. In one embodiment, the system 950 is implemented as a “smart phone” capable of running one or more applications (e.g., browser, e-mail, calendaring, contact managers, messaging clients, games, and media clients/players). In some embodiments, the system 950 is integrated as a computing device, such as an integrated personal digital assistant (PDA) and wireless phone.

One or more application programs 956 may be loaded into the memory 958 and run on or in association with the operating system 960. Examples of the application programs include phone dialer programs, e-mail programs, personal information management (PIM) programs, word processing programs, spreadsheet programs, Internet browser programs, messaging programs, and so forth. The system 950 also includes a non-volatile storage area 962 within the memory 958. The non-volatile storage area 962 may be used to store persistent information that should not be lost if the system 950 is powered down. The application programs 956 may use and store information in the non-volatile storage area 962, such as e-mail or other messages used by an e-mail application, and the like. A synchronization application (not shown) also resides on the system 950 and is programmed to interact with a corresponding synchronization application resident on a host computer to keep the information stored in the non-volatile storage area 962 synchronized with corresponding information stored at the host computer. As should be appreciated, other applications may be loaded into the memory 958 and run on the mobile computing device 900, including the model manager 626 as described herein.

The system 950 has a power supply 970, which may be implemented as one or more batteries. The power supply 970 might further include an external power source, such as an AC adapter or a powered docking cradle that supplements or recharges the batteries. The system 950 may also include a radio 972 that performs the function of transmitting and receiving radio frequency communications. The radio 972 facilitates wireless connectivity between the system 950 and the “outside world,” via a communications carrier or service provider. Transmissions to and from the radio 972 are conducted under control of the operating system 960. In other words, communications received by the radio 972 may be disseminated to the application programs 956 via the operating system 960, and vice versa.

The visual indicator 932 may be used to provide visual notifications, and/or an audio interface 974 may be used for producing audible notifications via the audio transducer 936. In the illustrated embodiment, the visual indicator 932 is a light emitting diode (LED) and the audio transducer 936 is a speaker. These devices may be directly coupled to the power supply 970 so that when activated, they remain on for a duration dictated by the notification mechanism even though the processor 980 and other components might shut down for conserving battery power. The LED may be programmed to remain on indefinitely until the user takes action to indicate the powered-on status of the device. The audio interface 1274 is used to provide audible signals to and receive audible signals from the user. For example, in addition to being coupled to the audio transducer 936, the audio interface 974 may also be coupled to a microphone to receive audible input, such as to facilitate a telephone conversation. In accordance with embodiments of the present invention, the microphone may also serve as an audio sensor to facilitate control of notifications, as will be described below. The system 950 may further include a video interface 982 that enables an operation of an on-board camera to record still images, video stream, and the like.

A mobile computing device 900 implementing the system 950 may have additional features or functionality. For example, the mobile computing device 900 may also include additional data storage devices (removable and/or non-removable) such as, magnetic disks, optical disks, or tape. Such additional storage is illustrated in FIG. 9B by the non-volatile storage area 962. Mobile computing device 900 may also include peripheral device port 940.

Data/information generated or captured by the mobile computing device 900 and stored via the system 950 may be stored locally on the mobile computing device 900, as described above, or the data may be stored on any number of storage media that may be accessed by the device via the radio 972 or via a wired connection between the mobile computing device 900 and a separate computing device associated with the mobile computing device 900, for example, a server computer in a distributed computing network, such as the Internet. As should be appreciated such data/information may be accessed via the mobile computing device 900 via the radio 972 or via a distributed computing network. Similarly, such data/information may be readily transferred between computing devices for storage and use according to well-known data/information transfer and storage means, including electronic mail and collaborative data/information sharing systems.

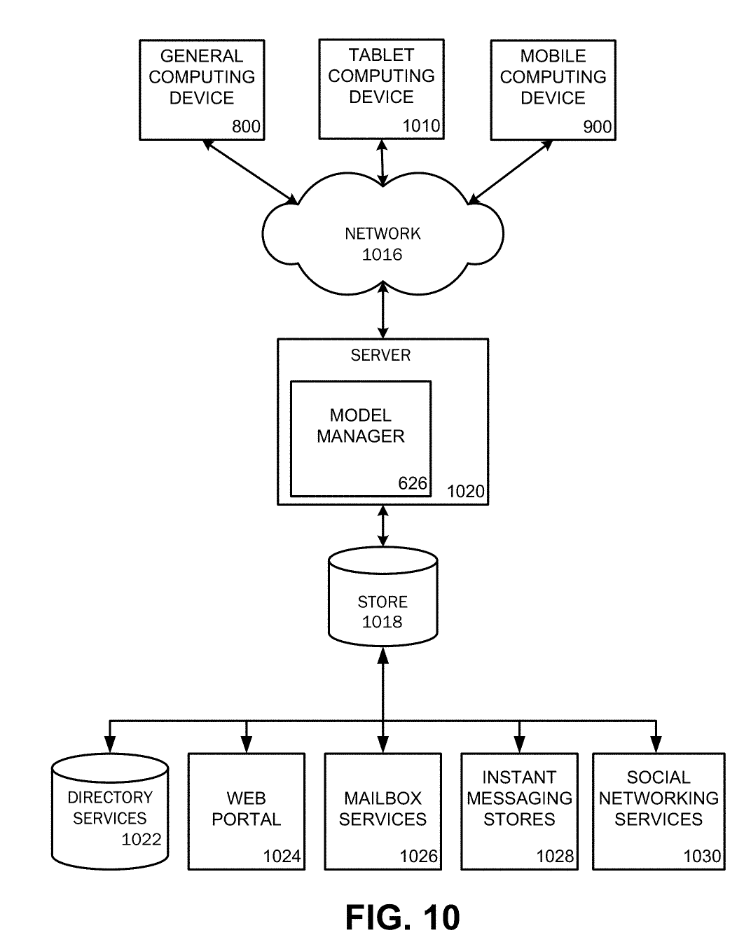

FIG. 10 illustrates an embodiment of an architecture of an exemplary system. Content developed, interacted with, or edited in association with the model manager 626 may be stored in different communication channels or other storage types. For example, various documents may be stored using a directory service 1022, a web portal 1024, a mailbox service 1026, an instant messaging store 1028, or a social networking site 1330. The model manager 626 may use any of these types of systems or the like for enabling data utilization, as described herein. A server 1020 may provide the model manager 626 to clients. As one example, the server 1020 may be a web server providing the model manager 626 over the web. The server 1020 may provide the model manager 626 over the web to clients through a network 1016. By way of example, the client computing device may be implemented as the computing device 800 and embodied in a personal computer, a tablet computing device 1010 and/or a mobile computing device 900 (e.g., a smart phone). Any of these embodiments of the client computing device 800, 1010, 900 may obtain content from the store 1018.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

What is claimed is:

1. A method comprising:
in response to received input, accessing, via a model manager, a Deep Neural Network (DNN) model comprising an embedding layer, stacking layer, deep layers and a scoring layer;
initiating training of the DNN model via the model manager to determine parameters of the embedding layer, the stacking layer, the deep layers and the scoring layer;
initializing parameters of an embedding layer of a Deep Embedding Forest (DEF) model with parameters extracted from the deep layers of the trained DNN model;
initializing parameters of a stacking layer of the DEF model with parameters extracted from the stacking layer of the trained DNN model; and
producing an output from the DEF model to computer memory.

2. The method of claim 1, further comprising, after training the DNN model, discarding the parameters of the deep layers and the scoring layer of the DNN model.

3. The method of claim 1 further comprising:
applying the initialized parameters of the embedding layer of the DEF model to features of the DEF model to generate a stacking vector;
providing the stacking vector to a forest layer of the DEF model; and
training only the forest layer of the DEF model, thereby using less memory and computation power.

4. The method of claim 1 wherein the DNN model reduces high dimensional features in the range of hundreds of thousands to millions to lower dimensional vectors of less than 10 thousand for initializing a forest layer.

5. The method of claim 1 further comprising discarding the parameters of the deep layers and the scoring layer of the DNN model and replacing the deep layers and the scoring layer of the DNN model with a forest layer to thereby define the DEF model.

6. The method of claim 5 further comprising initializing the forest layer of the DEF model utilizing a gradient boosting machine.

7. The method of claim 6 wherein accessing the DNN model comprises accessing a deep crossing model, the deep layers of the DNN model being multiple residual units of the deep crossing model, training the DNN comprises training the deep crossing model, and initializing the forest layer of the DEF model utilizing a gradient boosting machine comprises utilizing XEBoost to initializing the forest layer of the DEF model.

8. The method of claim 6 further comprising jointly optimizing the parameters of both the embedding layer and the forest layer of the DEF model after fully initializing the DEF model as a result of initializing the embedding and stacking layers of the DEF model and initializing the forest layer of the DEF model utilizing the gradient boosting machine.

9. The method of claim 1 wherein accessing a DNN model comprises accessing a deep crossing model and the deep layers are multiple residual units.

10. The method of claim 1 further comprising jointly optimizing the parameters of both the embedding layer and the forest layer of the DEF model utilizing partial fuzzification.

11. The method of claim 1 further comprising replacing the deep layers and the scoring layer of the DNN model with a forest layer to thereby define the DEF model, initializing the forest layer of the DEF model utilizing a gradient boosting machine, and jointly optimizing the parameters of both the embedding layer and the forest layer of the DEF model after fully initializing the DEF model as a result of initializing the embedding and stacking layers of the DEF model and initializing the forest layer of the DEF model utilizing the gradient boosting machine.

12. A system for implementing a deep embedding forest model, comprising:
at least one processor;
an operating environment executing using the at least one processor; and
a model manager configured to perform actions comprising:
accessing a Deep Neural Network (DNN) model comprising an embedding layer, stacking layer, deep layers and a scoring layer;
training the DNN model to determine parameters of the embedding layer, stacking layer, the deep layers and the scoring layer;
initializing parameters of an embedding layer of a Deep Embedding Forest (DEF) model with parameters extracted from the deep layers of the trained DNN model;
initializing parameters of a stacking layer of the DEF model with parameters extracted from the stacking layer of the trained DNN model;
applying the initialized parameters of the embedding layer of the DEF model to features of the DEF model to generate a stacking vector;
providing the stacking vector to a forest layer of the DEF model; and
training only the forest layer of the DEF model.

13. The system of claim 12 further comprising discarding the parameters of the deep layers and the scoring layer of the DNN model and replacing the deep layers and the scoring layer of the DNN model with a forest layer to thereby define the DEF model.

14. The system of claim 12 further comprising initializing the forest layer of the DEF model utilizing a gradient boosting machine.

15. The system of claim 12 further comprising jointly optimizing the parameters of both the embedding layer and the forest layer of the DEF model after fully initializing the DEF model as a result of initializing the embedding and stacking layers of the DEF model and initializing the forest layer of the DEF model utilizing the gradient boosting machine.

16. A computer-readable storage medium storing computer-executable instructions that when executed using a processor perform actions, comprising:
accessing, via a model manager, a Deep Neural Network (DNN) model comprising an embedding layer, stacking layer, deep layers and a scoring layer;
training the DNN model to determine parameters of the embedding layer, stacking layer, the deep layers and the scoring layer, wherein training the DNN model includes tuning the DNN model using back propagation;
initializing parameters of an embedding layer of a Deep Embedding Forest (DEF) model with parameters extracted from the deep layers of the trained DNN model;
initializing parameters of a stacking layer of the DEF model with parameters extracted from the stacking layer of the trained DNN model; and
initializing a forest layer of the DEF model utilizing a gradient boost machine; and
producing an output from the DEF model to computer memory.

17. The computer-readable storage medium of claim 16 further comprising:
applying the initialized parameters of the embedding layer of the DEF model to features of the DEF model to generate a stacking vector;
providing the stacking vector to a forest layer of the DEF model; and
training only the forest layer of the DEF model, thereby using less memory and computation power.

18. The computer-readable storage medium of claim 16 further comprising initializing the forest layer of the DEF model utilizing a gradient boosting machine.

19. The computer-readable storage medium of claim 16 jointly optimizing the parameters of both the embedding layer and the forest layer of the DEF model after fully initializing the DEF model as a result of initializing the embedding and stacking layers of the DEF model and initializing the forest layer of the DEF model utilizing the gradient boosting machine.

20. The computer-readable storage medium of claim 16 wherein accessing a DNN model comprises accessing a deep crossing model and the deep layers are multiple residual units.
